(19) United States
(12) Patent Application Publication
(10) Pub. No.: US 2013/0138450 A1
(43) Pub. Date: May 30, 2013

(54) DIGITAL HEALTH CARE ENVIRONMENT FOR IMPLEMENTING AND MONITORING PATIENT HEALTH CARE FOR CHRONIC DISEASES THROUGH CONFIGURABLE AND INTERACTIVE TASKS

(71) Applicant: Alexandre Vigneux, Longueuil (CA)

(72) Inventor: Alexandre Vigneux, Longueuil (CA)

(21) Appl. No.: 13/481,905

(22) Filed: May 28, 2012

Related U.S. Application Data
(60) Provisional application No. 61/490,948, filed on May 27, 2011.

(51) Int. Cl. G06F 19/00

(52) U.S. Cl. CPC G06F 19/34
USPC 705/2

(57) ABSTRACT

A system and method for coordinating a series of health related tasks for a chronic disease management in interaction with a patient device comprising: a task rule set customized for each patient of a plurality of patients registered with a management system, the customized rule set based on a health care plan for the patient administered by a clinician; implementing the task rule set customized for the respective patient; receiving patient health data dependent upon at least one specific task of the task rule set completed by the patient; transmitting the received patient data to a clinician device via a clinician interface; and transmitting a message to a parent device including content related to the patient health data including information about the one specific task of the task rule set completed by the patient. The task rule set can be embodied as a series of steps involving game play.

### CROSS-REFERENCE TO RELATED APPLICATION

This application claims the benefit of U.S. Provisional Application No. 61/490,948 filed May 27, 2011, and incorporates by reference the disclosure of said application in its entirety.

### FIELD

The present invention relates to electronically implemented health care.

### BACKGROUND

Most Children have problems adhering to care plan steps in management of their chronic disease, and parents often struggle to motivate children to comply with their care plan assigned by their doctor. Parents can develop higher anxiety as a result of this difficulty in management. Current popular management tools used to track care plans are paper based, and parents often “cheat” by filling them at the last minute before a scheduled appointment. However, many management tools can have some connectivity capabilities, making a information transfer possible to keep those care plan logs more accurate with less efforts. However, these current management tools do not provide the physicians and their staff with adequate interim visibility and interaction with patient progress between appointments, increasing the risk of untracked worsening situations leading to hospitalization of the patient due to mismanagement of their chronic disease.

Further, with rising costs, reduced access to clinicians and an aging and growing population demanding more say in the way their health and in particular management of their chronic disease(s) is done, there is a tremendous need for consumer health technology to enable the transformation of care delivery models within healthcare systems around the world. Internet access, wireless devices and mobility are enabling consumers to seek out and access health and wellness information, communicate more effectively with their healthcare providers and manage their health situation and that of their families in real time. In particular, what is needed is an adaptive health care tool that can reflect changes in a health care plan of a patient, such that the tool is customizable to the patient's health care needs while at the same to promoting the use of the tool by the patient in a desirable manner.

### SUMMARY

It is an object of the present invention to provide a tool for management of a series of health related tasks pertaining to a chronic disease that obviate or mitigate at least one of the above-presented disadvantages.

One aspect provided is a management computer system for coordinating a series of health related tasks in interaction with a patient device, the system comprising: a task rule set customized for each patient of a plurality of patients registered with the management system; a user interface accessible by the patient device configured for implementing the task rule set customized for the respective patient and configured for receiving patient health data dependent upon at least one specific task of the task rule set completed by the patient; a clinician interface accessible by a clinician device configured for transmitting the received patient data and for receiving proposed rule set modifications from the clinician device related to the transmitted patient data; and a modification module configured for modifying at least one task of the task rule set customized for the respective patient using the proposed rule set modifications, such that subsequent specific tasks completed by the patient are influenced by the modified at least one task.

A second aspect provided is a method for coordinating a series of health related tasks in interaction with a patient device comprising instructions stored on a physical storage for execution by a computer processor, the instructions comprising: a task rule set customized for each patient of a plurality of patients registered with the management system; implementing the task rule set customized for the respective patient; receiving patient health data dependent upon at least one specific task of the task rule set completed by the patient; transmitting the received patient data to a clinician device via a clinician interface; receiving proposed rule set modifications from the clinician device related to the transmitted patient data; and modifying at least one task of the task rule set customized for the respective patient using the proposed rule set modifications, such that subsequent specific tasks completed by the patient are influenced by the modified at least one task.

A third aspect provided is a method for coordinating a series of health related tasks in interaction with a patient device comprising instructions stored on a physical storage for execution by a computer processor, the instructions comprising: a task rule set customized for each patient of a plurality of patients registered with the management system, the customized rule set based on a health care plan for the patient administered by a clinician; implementing the task rule set customized for the respective patient; receiving patient health data dependent upon at least one specific task of the task rule set completed by the patient; transmitting the received patient data to a clinician device via a clinician interface; and transmitting a message to a parent device including content related to the patient health data including information about the one specific task of the task rule set completed by the patient.

Example objectives of the tools are:
Develop a game (and/or mini games) to keep the children motivated and on track with their care plans (or other objectives), educating them along the way. The care plan adherence rewards the child in the game and the child can eventually trade accumulated game points for virtual and real life rewards.
Develop parent tools, including alert and reminder mechanisms that help them accumulate care plan/objectives related tracking information more efficiently and in a timelier manner, and provide them interpretation tools (graphs, tables, etc.) helping them better understand the child's evolution and requesting assistance from the clinical team as required. The parents can interact with the reward levels of the game by setting thresholds to obtain them and purchasing virtual and real life rewards (or create their own) to offer freely or as a goal for the child.
Develop tools for the clinical support team (or expert) to follow the child progress and adherence to the care plan and communicate with the parents as needed.
Provide the child-parent-clinicians support model of the game is easily extendable and replicable to other chronic illnesses or objective-driven behavior change situations (i.e.: active/healthy living, sports, homework, etc., including adult use cases as a “user/close support/expert support” relationship like smoking cessation, weight loss, etc.).
Specifically for diabetes and other chonic diseases in which regular readings are part of the health care plan, the game is linked to an electronic health record and can provide parent and clinicians interfaces.
The game theme pertains to the chronic disease and is objective driven and linked to a third party system health record.

### BRIEF DESCRIPTION OF THE DRAWINGS

Embodiments of the present invention will now be described by way of example only with reference to the following drawings in which:

FIG. 1 shows a digital health care environment;

FIG. 2 shows an example communication and data storage embodiment of the environment of FIG. 1;

FIG. 3 shows an example patient interface of the application of FIG. 1;

FIG. 4 shows an example parent interface of the application of FIG. 1;

FIG. 5 shows a conceptual block diagram of components and subsystems of the devices of FIG. 1;

FIG. 6 shows an example operation of the application of FIG. 1;

FIG. 7 is an alternative embodiment of the interface of FIG. 4; and

FIG. 8 shows an example clinician interface of the application of FIG. 1.

### DESCRIPTION OF THE EMBODIMENTS

It is noted that as used herein, the term “portable device” is intended to encompass a wide range of digital devices including, without limitation, devices which transmit and/or receive digital information, such as mobile computers, mobile phones, handheld computers, digital cameras, and other electronic devices configured to transmit, receive, read and process wireless signals via one or more antennas. It is further recognized that the portable device can be embodied in a number of form factors, including smart phones, handheld personal digital assistants (PDAs), Ultra-Mobile PCs, Tablet PCs, and laptops that include one or more antennas configured for communicating over wireless networks. It is noted that as used herein, the term device includes portable devices and desktop devices. A desktop device can include those digital devices linked to the communication network via a land based network connection as compared to a wireless network connection, including those digital devices connected to the land based network connection via a local WiFi or other wireless network. The device can also include a personal computer or a server with a network connection configured to interact with a plurality of other networked devices simultaneously.

It is noted that as used herein, the term “antenna” is intended to encompass a wide range antenna applications including, without limitation, non-directional based antennas such as WAN, WIFI and/or Bluetooth communication technologies.

It is noted that as used herein, the term a web page or webpage is a document or information resource that is suitable for the World Wide Web and can be accessed through a web browser and displayed on a device monitor or mobile device. This information is usually in HTML or XHTML format, and may provide navigation to other web pages via hypertext links. Web pages frequently subsume other resources such as style sheets, scripts and images into their final presentation. Web pages may be retrieved from a local computer or from a remote web server. The web server may restrict access only to a private network, e.g. a corporate intranet, or it may publish pages on the World Wide Web. Web pages are requested and served from web servers using Hypertext Transfer Protocol (HTTP). Web pages may consist of files of static text and other content stored within the web server's file system (static web pages), or may be constructed by server-side software when they are requested (dynamic web pages). Client-side scripting can make web pages more responsive to user input once on the client browser.

### Overall Environment 10

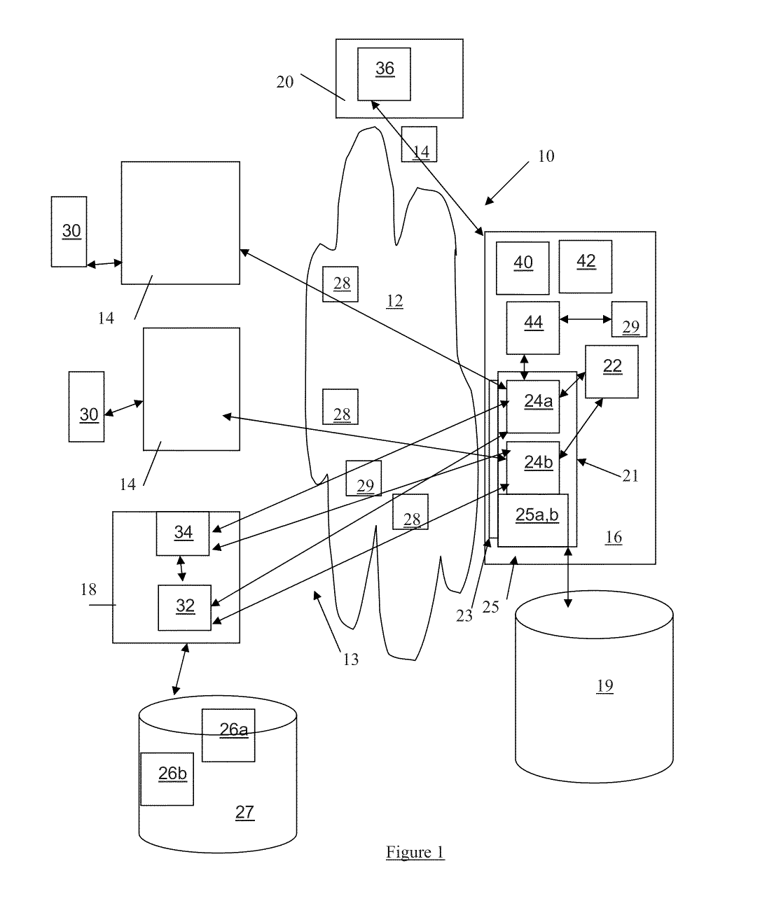

Referring to FIG. 1, task rules 22 and associated task content 25 is provided as chronic disease management application 21 (e.g. diabetes-specific module) offered on a management device 16, for example as a downloadable application to a patient device 14 as a stand alone application, as a downloadable application to the patient device 14 that provides access in a client service relationship with a web service interface 23 hosted by the management device 16, and/or as a hosted application accessible over the communications network 11 (e.g. the Internet) communicated via HTTP or other communications standards based messaging, as desired. The application 21 and/or associated interface 23 provides a platform that allows individuals (patients, parents of the patients) to manage, consult, control of their family's health and medical data 28 with one or more clinicians (e.g. doctor or doctors in charge of patient and administration of health care plan 26a,b of the patient). In use of the application 21, children as the patients learn about their chronic disease (e.g. diabetes) by playing (e.g. game play via task rules 24a,b) in a positive environment, the parents find tools via the parent interface of the application interface 23 to be pro-active in the monitoring of their child's health, and healthcare providers (e.g. clinicians) can also benefit from access to centralized, comprehensive records including the health related data 28 collected by the application 21. It is recognised that diffeent versions of the applcaiton 21 can be defined and implemented by the management device 16 for different age groups, e.g. one application 21 version for kids 4-8 years old, a different application 21 version for kids 9-13 years old and further different application 21 version for kids 14 years old and older.

In implementation of the application 21, advantages of interaction of the patients with the application 21 that result in the generation of the health related data 28 are: simple game play as defined by the task rules 24a,b, kids discover a stimulating universe and are rewarded for healthy choices; children can play in a positive and uplifting environment and can learn key concepts that will serve them throughout their lives about their disease; and the application can provide a fun and tailor-made environment especially designed for specific age groups having the disease (e.g. 4 to 8 year old diabetic children). Further advantages can be that kids are encouraged to lead a healthy lifestyle (good eating and physical exercise) through interaction with the task rules 24a,b by getting adherence rewards based on the adherence of the content of the health related data 28 to adherence thresholds, and the kids can be put in contact with a community of players (other patients using the application 21 via the application interface 23) to exchange messages 13, share their stories 13, play together through duels and participate in collective creations also via messages 13. One objective of the application 21 is to bring the experience for the patient beyond the screens and learn to become more independent in the daily management of their disease.

It is recognized that the health related data 28 that is collected via the management application 21 is made available to the health care plan 26a,b of the patient by the management device 16, as further described below. Examples of the chronic health conditions can be such as but not limited to: diabetes; hypertension; heart failure; pregnancy; and asthma. Accordingly, interaction with the application 21 via following game play defined by customized task rules 24a,b (of the general rules 22) and customized content 25a,b (of the general content 25) can increase treatment adherence levels through the simplicity of the integrated system and rewards given based on adherence to the care plan 26a,b (based on an adherence threshold) of the patient, such that the customized task rules 24a,b and the customized content 25a,b are based on the individual care plan 26a,b of the patient. One example of the adherence threshold is number of medical device 30 readings taken each day, such that a lower number of readings than the specified readings threshold would correspond to a less value of the award (e.g. points) assigned to the patient, while a higher number of readings closer to the specified readings threshold would correspond to a higher value of the award (e.g. points) assigned to the patient.

For example, the task rules 22 and general content 25 could be rules, workflow, and content for a generic diabetes application 21 that would involve dietary selection, reporting and information relevant to appropriate diabetes management, instructions including timing for operation of a blood glucometer, planning of specific meals and suggestion of specific sports or other activities, as well as degree of difficulty of the game play based on the patient capabilities and age. Therefore, the customized task rules 24a,b for the individual patient with diabetes could be a customized version of the general diabetes task rules 22 including: dietary selections relevant to the dietary requirements of the patient as suggested in the care plane 26a,b; specified reading frequency and anticipated blood sugar levels; patient's age and specified game difficulty degree level; and/or type of and/or magnitude of prizes or other awards (some of which may be specified by the parent) that are awarded to the patient based on the degree of adherence to the care plan 26a,b as evidenced by the health data 28 collected by the application 21 during interaction of the patient via the patient user interface during game play. Additionally, for any modifications 29 incorporated into the customized task rules 24a,b, a greater level or degree of award could be given to the patient in order to promote adoption of the changes dictated by the modifications 29. In other words, the modifications 29 would be use to reconfigure the application 21 for the patient by amending the customized task rules 24a,b based on updates to the care plan 26a,b that are reflected in the modifications 29 (e.g. sent in by the clinician to the management device 16 via the clinician device 18. It is also recognized that the management device 16 could have different versions of the general task rules 22, one for each type of chronic disease (e.g. diabetes, hypertension, etc.). In this manner, the management device can provide for different versions of the application 21 for different chronic diseases that are in turn customized for different patients based on their health care plan 26a,b.

The chronic disease management application 21 is an interactive tool provided to the patient to facilitate a unique environment designed for children (e.g. aged 4 to 8, 9-12, 12-18) who live with the chronic disease. Not only is the chronic disease management application 21 configured as a learning assistance tool, but the application 21 can also provide a useful management platform for parents who have to closely monitor their child's health in order to have the most recent and relevant information at the disposal of the clinicians in charge of their child's disease condition.

Accordingly, the environment through the application 21 can also be configured as a communication platform, thereby providing the parents, clinicians and other health-care professionals in charge of their child's health to exchange factual data 28 collected by the application 28 (via interaction of the child with the application 21)on the child's disease condition, as well to provide for exposure of the child to educational content 25a,b and learning tasks defined by task rules 24a,b that is relevant to the chronic disease . The environment 10 via the application 21 interaction, collection of data 28 that is made available to the health care plan 26a,b, and/or modification potential (via modification data 29) of the task rules 24a,b provides for a collaborative environment (e.g. patents, child, clinician) to properly manage the child's chronic disease by providing the ability to adjust a treatment (as represented by the care plan 26a,b) when necessary. One example is where the task rules 24a,b dictate that the application 21 instruct the patient via game play to provide medical device 30 readings (e.g. glucometer readings) as the health data 28 for specified times and/or to indicate (e.g. via user presented selections) what types and/or quantities of foods the patient has been ingesting between readings. Based on the received data 28, the clinician can incorporate this data 28 with other relevant patient data in the health care plan 26a,b of the patient and then provide update/modifications to the task rules 24a,b and/or related health content 25a,b to the application 21 for subsequent interaction with the patient (e.g. the modifications 29 changing the suggested frequency of readings and/or providing warning or encouraging comments to the patient when certain food selections are entered by the patient that would affect negatively or positively, respectively, the meter readings).

Accordingly, in view of the above, the application 21 and interaction of the application 21 configuration (e.g. task rules 24a,b and/or related content 25a,b) with the patient and clinician provides for a better understanding of chronic disease (e.g. diabetes) and it's management by the children who live with the condition, improved management of the daily data by their parents and improved communication between the parents, clinicians and health-care personnel all contribute to reduce complications risks and hospitalizations due to less than optimal monitoring.

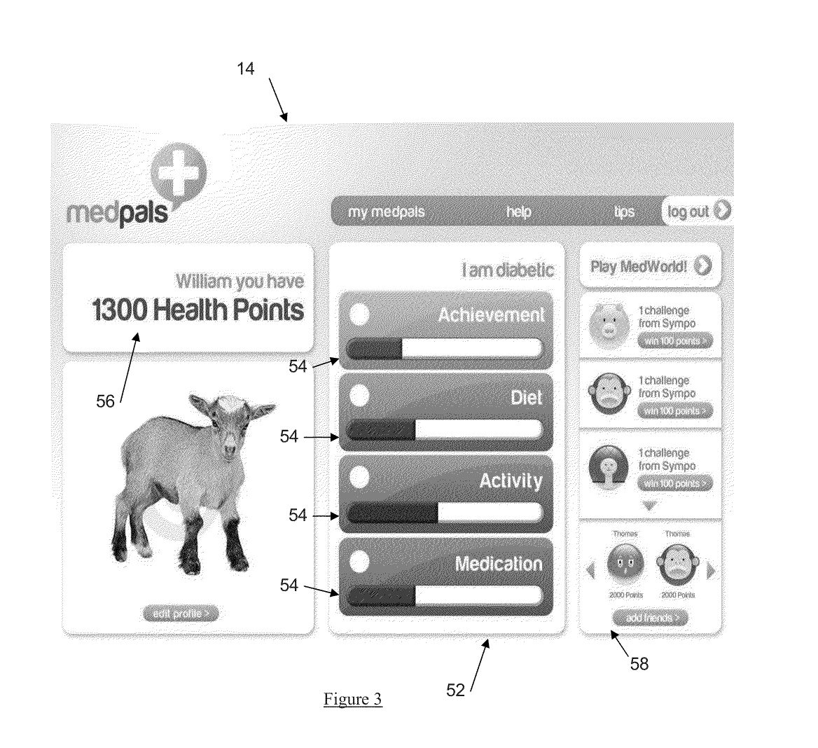

From the patient's point of view, interaction with the application 21 can provide for the patient to care for a virtual buddy (e.g. an avatar associated with a patient account of the management device 16 associated with the application 21 such as but not limited to a baby lamb, a baby bunny, or other avatars selectable or otherwise configurable by the patient), who lives in a fantastic environment that is affected by the progression (improvement or lack of improvement or degradation) of the patient's chronic disease (as indicated by the health data 28 provided to the application 21 by the patient) In this example, a condition and/or behavior of a virtual character of the application 21 is affected by the health data 28 provided to the application 21 in response to the interaction of the patient with the application 21 as dictated or otherwise driven or guided by the task rules 24a,b and/or health content 25a,b (e.g. what is used by the environment 10 to configure the application 21 as customized for the patient's chronic disease and current related health condition). Configuration of the application 21 shows the patients, in a very intuitive and playful way, what their condition is all about in an educational manner as well as in a personal management manner (e.g. provides the patient with the ability to affect their treatment of their condition). The application 21 integrates notions about the condition and what it means to live with it on a daily basis. The application 21 provides for friendly and entertaining interaction with the patient (e.g. provides tasks via the task rules 24a,b and presentation of content 25a,b via the user interface of the patient device 14), and can help children become autonomous in the management of their condition. It is recognized that the perceived health condition of the avatar, which is associated with the patient's account of the application 21 on the management device 16, is indicated by game goals 54 of FIG. 3. For example, the provision of the health data 28 to the management device 16 is done (e.g. frequency of generation of the health data—for example through game play and/or collection and submission via the medical device 30) according to the customized task rules 24a,b that are based on the health care plan 26a,b of the patient. In this manner, the application 21 awards or does not award points 56 and/or increase the level of game goals 54 (e.g. level of achievement, diet, activity, and medication), which can be a reflection of the perceived health or wellness condition of the avatar by the patient.

Referring to FIG. 3, shown is an example content 25a,b of the application 21 presented on the user interface of the patient device 14, including details of the current status 52 of the game play of the patient including progression towards game goals 54 related to the chronic disease, award level 56 that is representative of the game goals 54, and interaction status 58 with other patients of the environment 10.

From the parent's standpoint, interaction with the application 21 via the parent device 20 (and/or via the patient device 14 using a parent account associated with the patient account of the application 21), parents can easily update their child's daily data 28 that is then made available to the online medical file (e.g. part of or otherwise associated with the health care plan 26a,b). This access ability (for update/modification as well as viewing/reading) gives the parents a useful overview of the current situation of their child's chronic disease and management thereof (for example having the ability to review blood monitor readings 28 of the patient, insulin charts 28 of the patient, send messaging 13 to the patient, and/or reviewing the scheduling of the medical device 30 operation). Most of all, the parents can access this data 28 as well the as health care plan 26a,b at any time from almost anywhere—from home or at work, even on vacation—, as long as they have access to their parent device 20 (e.g. a parent account of the application 21 that is related to the child account of the application 21) computer. One advantage of the application 21 is that it provides parents with the ability to centralize, visualize and/or transmit their child's medical data 28 collected by the application 21 as well as any associated data already resident in health care plan 26a,b (for example historical data 28 previously collected by the application 21), which can reduce the stress associated with living with the chronic disease. Further, it is recognized that the parent can from their parent account interact with their child during game play due to the interactive configuration of the game play between the devices 14, 18, 20 through the application 21 via the application interface 23.

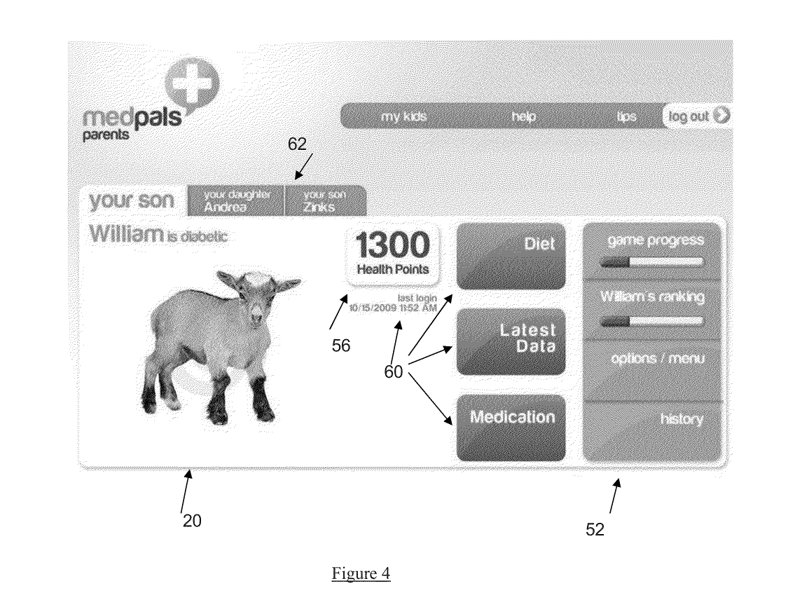

Referring to FIG. 4, shown is an example content 25a,b of the application 21 presented on the user interface of the parent device 20, including details of the current status 52 of the game play of the patient including progression towards game goals 54 related to the chronic disease, award level 56 that is representative of the game goals 54, activity status 60 including details of diet, medication, readings data 28 collected as a result of interaction of the patient with the application 21, separate tabs 62 for each child under the care of the parent with other patients of the environment 10. Further, the application 21 via the user interface can also provide the parent with the ability to participate in access to the personal information of their child associated with the application 21 (e.g. collected data 28 both present and historical, various application statuses as provided above) as well as mail, instant chat, discussion boards and personal blogs, for example, with other parents and the clinician via messages 13 via the merchant device 13 (e.g. via the application interface 23) used to connect all of the devices 14, 18, 20 in the medical community set up through the application 21.

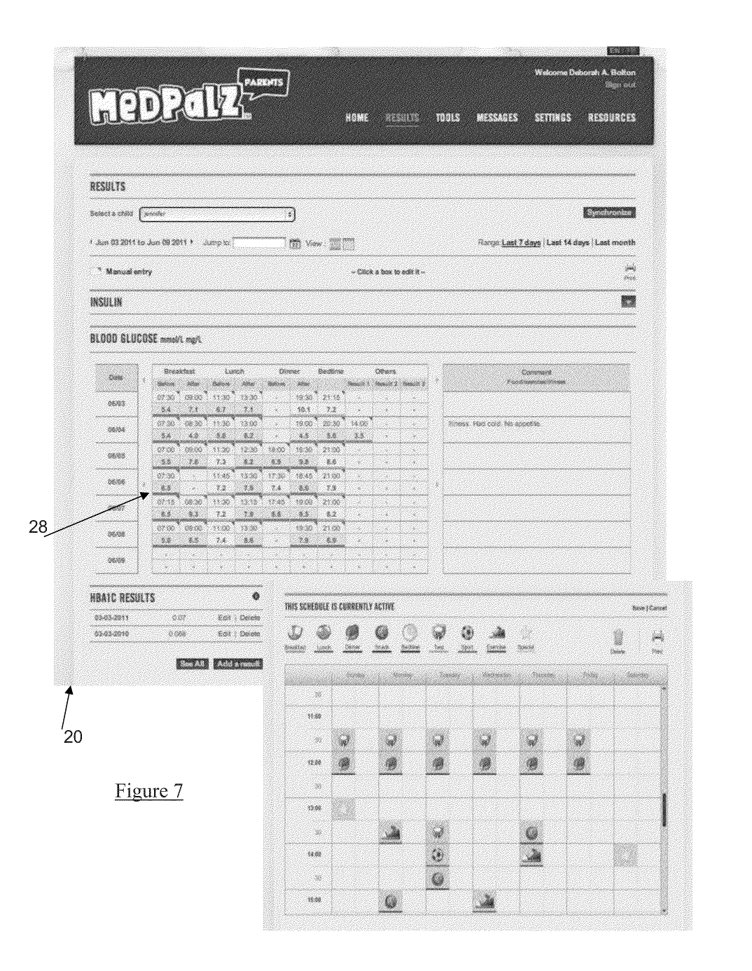

Referring to FIG. 7, shown is an alternative interface of the parent device 20, showing parents have access to a variety of tools to be pro-active in the monitoring of their child's health. Data collection is facilitated by keeping track of their child's blood glucose readings 28; simple monitoring is facilitated by simple graphics providing parents the ability to closely monitor their child's progress and make adjustments when they see fit. Personalised messages 13 can also be sent to the treating physician, as well as the receipt of automated notifications 13 from the application 21 providing status on their child's activities and interactions with the application 21. Also shown on the parent interface can be plan meals, tests and sports, as well as a convenient schedule maker keeping track of weekly patient activities.

From the clinicians' standpoint interaction with the application 21 (e.g. configuration of task rules 24a,b, health content 25a,b and/or contents of the health care plan 26a,b) via the clinician device 18 and management device 16, the environment 10 provides for contextualized monitoring of a child's condition related to the chronic disease. For example, based on the initial diagnosis of the chronic disease and the updated content of the health care plan 26a,b (via the collected health data 28), the clinician can configure the task rules 24a,b, health content 25a,b of the application 21 to provide for application functionality and/or content related to using email alerts, graphs, and an exhaustive list of activities, meal schedules, and specific events that can influence the child's condition, all of which are presented to the patient during interaction with the application 21 via the patient device 14 in the form of game play. In this manner, clinicians can remotely adjust (via modifications 29) a treatment or give instruction on how to act in a given situation as presented to the patient using game play of the application 21 as implemented through the customized task rules 24a,b and/or content 25a,b that are reflective of the contents of the health care plan 26a,b data as well as incorporate the received health data 28 as continually collected over time (e.g. during or otherwise as a consequence) due to ongoing interaction of the patient with the application 21 while being treated or otherwise managed by the clinician. For example, the modifications 29 to the task rules 24a,b and/or content 25a,b can adjust an insulin dosage and frequency, medical device reading frequency and/or reading directions, suggestion content of appropriate foods and beverages, suggestion of appropriate activities, discourage content for inappropriate foods and beverages, discourage content for inappropriate activities, provide adjustments to games and/or difficulty level of games (e.g. specific tasks or game workflow or game content) based on patient progress of the games, look at the patient's history and access their medical data such as age, height, weight, etc. It is recognized that the clinician can access real-time health data 28 and can make adjustments to the operation of the application 21 by sending modification data 29 to the management device 16 for subsequent use in revising the customized task rules 24a,b and/or content 25a,b.

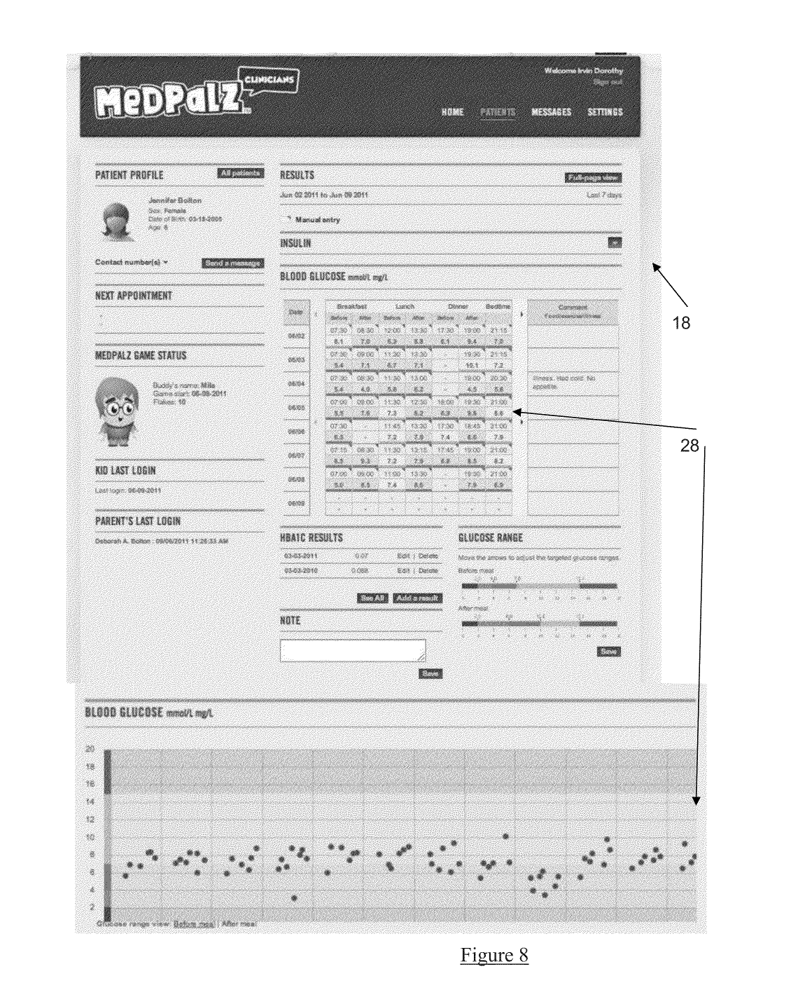

Referring to FIG. 8, shown is an example interface of the clinician device 18, showing consistent data 28 of blood test results collected directly from the child's blood glucose meter gives them detailed readings on blood glucose variations with understandable graphics of their patients data that can highlight issues in a patients daily routine. Also included can be detailed readings along with parent comments (part of the collected health data 28 generated by task rules 24a,b requesting or otherwise providing for patent input data 28 on data 28 previously collected from the patient) that can provide additional understanding of their patients results.

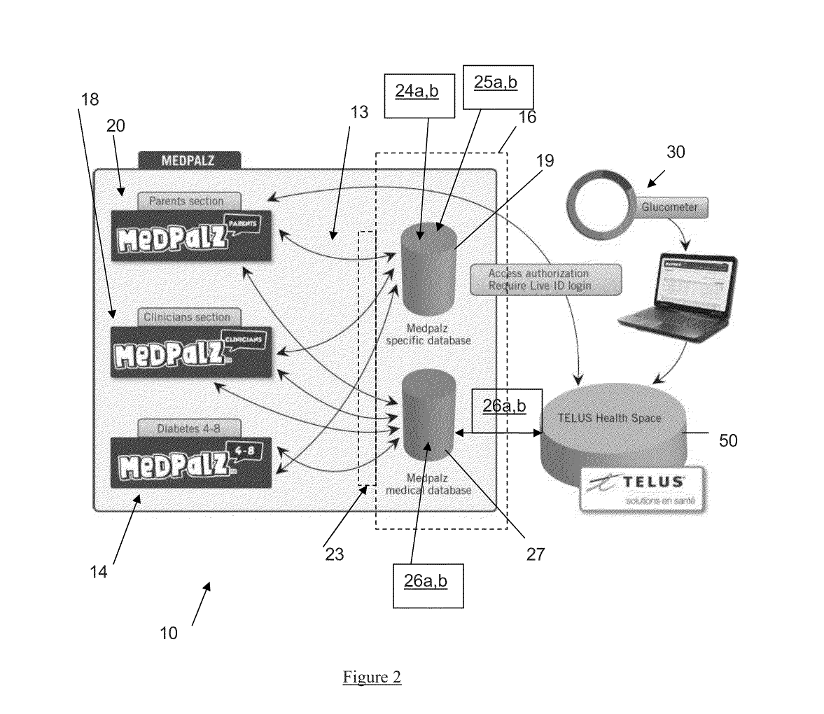

Referring to FIG. 2, shown is messaging 13 (e.g. network messages containing the collected health data 28 and the update modification data 29) between the computer devices 14, 16, 18, 20 and the storage database 19 (used to contain the application 21 configuration files in the form of the task rules 22, 24a,b and the health content 25, 25a,b) and the storage database 27 (used to contain the health care plans 26a,b of the patients). For example, it is recognized that the storage database 19 is used by the management device 16 to implement the application 21 for access by the devices 14,18,20 (e.g. via the interface 23 via URLs and/or for download from the management device 16 over the network 11 for installation on the device(s) 14,18,20), including facilitating the coordination of collection of the health data 28 (provided by the patient) or analysis/processing results of the health data 28, access to the collected health data 28 by the parent and/or clinician via their respective devices 20,18, as well as generation and receipt of the modification data 29 for use in subsequent updating or modification of the task rules 24a,b and/or health content 25a,b. Further, the data content of the health care plans 26a,b can be retrieved from or otherwise stored in a health care database 50 that is not dedicated to the configuration an implementation of the application 21. For example, the health care database 50 can contain health care records of the patient that are not related to management of the chronic disease (e.g. medical history of non-chronic diseases, family medical history, prescription information, lab and trest results, hospital records, etc.).

Referring to FIG. 1, shown is the digital health care environment 10 including one or more communication networks 12 providing for data communications (e.g. text, audio, images) between the patient device 14, the management device 16 and the clinician device 18. Optionally, the parent device 20 can also interact with the management device 16 separately from the patient device 14 and/or both the patient and the parent can use the same device 14,18 for access and interaction with the management device 16.

The management device 16 can be configured to operate as a Web service for providing a software system designed to support interoperable machine-to-machine interaction over the network 12. The management device 16 has an interface described in a machine-processable format (e.g. Web Services Description Language WSDL). Other systems interact with the Web service in a manner prescribed by its description using SOAP messages, typically conveyed using HTTP with an XML serialization in conjunction with other Web-related standards. The management device 16 hosts a set of task rules 22 (e.g. game rules where the concept of a game is described further herein) that can be executed by the processor of the device 16 to present a health related task workflow (e.g. steps of a health related game) as a series of interconnected Web pages (and respective content 25) as accessible via the Web service by the other devices 14,18,20, as viewed and interacted with via the respective user interface 202 of the device 14,18,20. As an example, task rules 22 can be videogame rules and task workflow can be videogame workflow that is provided to and interacted with by the patient (via the patient device 14) from the management device 16 via the network 12. Examples of the tasks (e.g. embodied as a game) as well as interfaces (e.g. network accessible Web pages) associated with the patients, patents, clinicians are shown by example in the attached figures. It is also recognised that the task rule sets 22,24a,b can be stored on the patient device 14, rather than the management device 16, or a combination thereof (e.g. shared), as desired. In the case of the task rule sets 22,24a,b stored on the patient device 14 itself, the expression of the task rule sets 22,24a,b would be on the device user interface 202 (see FIG. 2) as one or more screens.

It is recognised that the task rules 22 can be provided as a series of customized task rule sets 24a,b (e.g. including customized associated Web pages, page content, page functionality, and workflow between pages) for each of the patients accessing the management device 16 via their respective patent devices 14. It is in this manner that customized versions of the task rules 22 (e.g. customized versions of the same game) are presented to and interacted with each of the respective patient devices 14. The customized task rule sets 24a,b are related to the customized individual health care plan 26a,b accessible by the clinician via the clinician device 18, as further described below. The clinician (via the clinician device 18) can also affect (e.g. add, modify, delete one or more task rules 24a,b) for a respective patient dependent upon the data 28 received from the patient in response to the patient interacting with the respective tasks provided by the management device 16 (as configured by the task rules 22,24a,b). One example of this is the patient playing a videogame (as provided by the management device 16) having format/content/workflow as defined by the respective customized task rules 24a,b and/or task rules 22. The task rules 22,24a,b can be stored in a storage 25 accessible (e.g. locally or remotely over the network 12) by the management machine 16

The management device 16, through interaction with the patient device 14 receives health related data 28 for communication to the clinician device 18. One example of the data 28 is progression of the patient through the health related task workflow (e.g. current/historic task level of a plurality of potential task levels, current/historic task score as an indicator of progress/success in completing various tasks of the task workflow, and/or specific information entered by the patient and/or parent in response to task(s) presented to the patient/parent—for example entered/selected text/image answers/responses to a presented task). The data 28 can also be health data of the patient as captured by a suitable electronic health device 30 associated with the particular disease of the patient. Examples of the health device 30 are a glucometer, an electronic thermometer, a heart monitor, a blood pressure monitor, etc. In any event, it is recognised that the data 28 is collected by the management device 16 in relation to progression/interaction of the patient (via the patient device 14) with their respective customized task rule set 24a,b and associated task workflow.

It is also recognised that the task rules 22 via the rules 24a,b can specify/define the timing (e.g. frequency) of receipt as well as request to the patient for entry of the data 28 for subsequent transmission and receipt by the management device 16. For example, playing the videogame (as defined and implemented by the task rules 20,24a,b) by the patient can be specified by the game on a play schedule (e.g. once a day, a certain time everyday, a specified number of times a day, a specified time interval between playtimes, etc.). Progression and/or performance in the game can be dependent (as per the task rules 22,24a,b) on how closely the actual game play of the patient coincides with the defined timing. For example, glucose meter 30 readings 28 may be required once per day and therefore the rules of the game would expect as well as remind the patient of this requirement during play. It is recognised that the type and/or timing/frequency of the data 28 received by the patient can be defined in the respective health care plan 26a,b of the patient.

In view of the above, it is recognised that the clinician (via the clinician device 18) can affect the content and/or logic of the customized task rules 24a,b of a respective patient, as dependent upon the respective data 28 received and reviewed by the clinician via the clinician device 18, in comparison with the defined health plan data of the respective health plan records 26a,b of the respective patient. For example, the received data 28 can represent a series of glucose meter readings submitted by the patient in response to various tasks encountered during interaction with their customized task rules 24a,b,c and associated Web pages. The clinician can use a comparison module/interface 32 to access the defined (e.g. prescribed) magnitude/frequency of blood sugar levels in the patient health plan 26a,b and compare those to the received glucose data 28 in order to determine if the received glucose data 28 satisfies the defined (e.g. prescribed) magnitude/frequency of blood sugar levels in the patient health plan 26a,b. In the event that the clinician determines that there is a substantive deviation (e.g. readings are too frequent than specified, are less frequent than specified, glucose values are lower than specified, and/or glucose values are higher than specified) of the glucose data 28 from those in the defined health plan 26a,b, the clinician can use a modification module/interface 34 to access the management device 16 to have the respective task rules 24a,b modified in order to affect the presentation of the tasks to the patient in an effort to correct the determined deviation.

For example, the clinician can send instructions 29 to change the task settings in the respective task rules 24a,b to have the glucose meter readings 28 taken at different intervals/timing as originally defined in the respective task rules 24a,b. Accordingly, once the respective task rules 24a,b have been update or otherwise modified to account for the deemed deviation, subsequent interaction of the patient with their task rules 24a,b would reflect the differently defined intervals/timing. For example, videogame play would be modified for the patient, thereby incorporating the changes to the customized task rules 24a,b of the patient, and a different timing/frequency for data 28 submission (e.g. meter readings) would be experienced by the patient. Also, as evident, subsequent progression/success in the tasks by the patient would also be affected by the above-described updates/modifications to the customized task rules 24a,b of the patient.

Further, it is recognised that the customized task rule set 24a,b can be defined to affect any of the format, content (e.g. images, audio, text), functionality (e.g. navigation ability/extent between tasks on the same and/or different Web page(s), specified timing/frequency of interaction by the patient for supplying the data 28, or any other patient experience of the task(s) (e.g. game) via the patient device 14.

Further, it is recognised that the parent (or other legal guardian) can via the parent device 20 access the task(s) progress/success of the patient, can via a suitable interface 36 affect the customized task rule set 24a,b (e.g. set prize limits, prize types, etc. dependent on certain task completion, task performance, task success/score, and/or adherence level to task frequency/timing) so as to encourage the patient to interact with the tasks (e.g. videogame).

In terms of the management device 16, this device can be configured for coordinating a series of health related tasks in interaction with the patient device 14. The management device 16 can have the task rule set 24a,b customized for each patient of a plurality of patients registered with the management device 16. A patient interface 40 is accessible by the patient device 14 and configured for implementing the task rule set 24a,b customized for the respective patient and configured for receiving patient data 28 dependent upon at least one specific task (e.g. completing a specific game level, selecting a specific option presented via the tasks 24a,b, submitting of a device 30 reading 28, etc.) of the task rule set 24a,b completed by the patient. A clinician interface 42 is accessible by a clinician device and configured for transmitting the received patient data 28 and for receiving proposed rule set modifications 29 from the clinician device 18 based on an analysis of the transmitted patient data 28. A modification module 44 configured for modifying at least one task of the task rule set 24a,b customized for the respective patient using the proposed rule set modifications 29, such that subsequent specific tasks completed by the patient are influenced by the modified at least one task. For example, the modifications 29 can be related to timing/frequency of specific tasks of the task rule set 24a,b, can be related to a value or type of health care related reading data 28, and/or can be related to changes in the format, content, and/or functionality of the tasks presented to or otherwise interacted with by the patient via the patient device 14 (as defined by the modified version of the task rule set 24a,b). Further, it is recognized that the comparison module 32 is configured for comparison of the received patient data 28 with corresponding data in a health care plan 26a,b of the patient, such that the proposed rule set modifications 29 are a result of the comparison.

In terms of a health care plan 26a,b, this data can be stored in a storage 27 accessible by the clinician device 18. The health care plan 26a,b can contain medical records, health records, or medical charts in general as a systematic documentation of a single patient's long-term individual medical history and care. The term ‘Medical record’ is used both for the physical folder for each individual patient and for the body of information which comprises the total of each patient's health history. Although medical records are traditionally compiled and stored by health care providers, personal health records (PHR) maintained by individual patients have become technically available. The information/data contained in the health care plan 26a,b allows health care providers (e.g. clinicians) to provide continuity of care to individual patients for their chronic disease that is relevant to the tasks defined in their task rule sets 24a,b. The medical record also serves as a basis for planning patient care, documenting communication between patient, the health care provider and any other health professional contributing to the patient's care.

Further, the health care plan 26a,b can contain written orders by medical providers are included in the medical record. These detail the instructions given to other members of the health care team by the primary providers. Further, the health care plan 26a,b can contain (daily) updates entered into the medical record documenting clinical changes, new information, etc. These can often be entered by all members of the health-care team (doctors, nurses, physical therapists, dietitians, clinical pharmacists, respiratory therapists, etc.). They can be kept in chronological order and document the sequence of events leading to the current state of health for the chronic disease related to the task rule sets 24a,b. Further, test results and associated data (e.g. received data 28), such as blood tests (e.g., complete blood count) radiology examinations (e.g., X-rays), pathology (e.g., biopsy results), or specialized testing (e.g., pulmonary function testing) can be included. Other information stored in the health care plan 26a,b can be digital images of the patient, flowsheets from operations/intensive care units, informed consent forms, EKG tracings, outputs from medical devices (such as pacemakers), chemotherapy protocols, and numerous other important pieces of information form part of the record depending on the patient and his or her set of illnesses/treatments for the chronic disease represented/reflected in the specific format/content/functionality of task rule set 24a,b as experienced by the patient through interaction via the patient device 14 with the management device 16

Further, the defined plan data (as well as received historic data 28) can take many forms. There are several types of information that can be specified while tracing/treating the state of a patient's daily health, for example data such as but not limited to: 1. Vital Signs: Body Temperature, Pulse Rate(Heart Rate), Blood Pressure and Respiratory Rate; 2. Intake: Medication, Fluid, Nutrition, Water and Blood, etc; 3. Output: Blood, Urine, Excrement, Vomit and Sweat, etc; 4. Observation of Pupil size; 5. Capability of four limbs of body; and/or any other data as potentially recordable by the electronic health device 30 and transmittable over the network as data 28.

### Task Rule Set 22 and Related Content 25

As discussed above, the task rule set 22 is a global rule set specifying a series of steps incorporated as a video game, otherwise referred to as Video games are computer- or microprocessor-controlled games. Computers can create virtual spaces for a wide variety of game types. The video game can simulate conventional game objects like cards or dice, while others can simulate environs either grounded in reality or fantastical in design, each with its own set of rules or goals. The computer or video game can use one or more input devices of the patent device 14, such as a button/joystick combination (on arcade games); a keyboard, mouse and/or trackball (computer games); and/or a controller or a motion sensitive tool, as well as the medical device 30.

The health care content 25 (e.g. text, audio, video, pictures), and the customized versions 25a,b of the content 25 for the patients, can be such as but not limited to an insulin dosage and frequency, medical device reading frequency and/or reading directions, suggestion content of appropriate foods and beverages, suggestion of appropriate activities, discourage content for inappropriate foods and beverages, discourage content for inappropriate activities, provide adjustments to games and/or difficulty level of games (e.g. specific tasks or game workflow or game content) based on patient progress of the games, appropriate messages based on patient progress or lack of progress with the game play, and/or amount and/or type of prizes or rewards associated with deemed adherence to the care plan 26a,b as evidenced through the collected health data 28.

The task rules 24a,b of the video game (customized versions of the task rules 22 that are therefore specific for the patient as set up by the clinician in view of the patient health care plan 26a,b) can define adventure and action involving the patient guiding a character from a third person perspective through a series of obstacles. This “real-time” element cannot be easily reproduced by a board game, which is generally limited to “turn-based” strategy; this advantage can allow the video games to simulate game situations more realistically. Lastly, a computer can, with varying degrees of success, simulate one or more human opponents in traditional table games such as chess, leading to simulations of such games that can be played by a single player. Other alternatives are in more open-ended computer simulations, also known as sandbox-style games, such that the task rules 24a,b provide a virtual environment in which the player may be free to do whatever they like within the confines of this universe, in view of some defined goals or opposition related to their disease. The task rules 24a,b can also be used to define role-playing games as a game in which the patient assumes the role(s) of character(s) acting in a fictional setting related to the disease of the patient. The patient may collaborate (e.g. with the parent and/or medical practitioner as a player(s) in the game along with the patient—i.e. a multiplayer interactive game) on a story involving those characters; create, develop, and “explore” the setting; or vicariously experience an adventure related to the disease of the patient.

Key components of games are goals, rules, challenge, and interaction. Games generally involve mental or physical stimulation, and often both. Many games help develop practical skills, serve as a form of exercise, or otherwise perform an educational, situational, or psychological role. The game is a system in which players engage in an artificial conflict, defined by rules, that results in a quantifiable outcome. The game is a form of art in which participants, termed players, make decisions or choices in order to manage resources through game tokens in the pursuit of a goal related to the disease of the patient. • In any event, application of the task rules 24a,b in the form of the game presented on the user interface of the patient device 14 includes the presentation of content 25a,b (e.g. facts and/or figures in the form of text, picture, video, and/or sound that is meant as informative content of the chronic disease). For example, the content 25a,b can be provided via the application of the task rules 24a,b as a response to a query or action performed by the patient (e.g. user event) and/or can be provided prior to the performance of a query or action by the patient, as desired. Accordingly, the game via the task rules 24a,b and related content 25a,b can offer a web based virtual world with mini games where the patient can play and learn very subtly about their chronic condition. Alternatively, the game can be provided to the patient as access to a weekly-renewed (for example by the modification module 44 providing the updates/modifications 29, or other specified renewal frequency other than weekly) portal where the patient can socialize with other patients (e.g. free from text, removing language barriers and requirement for monitoring), access mini games, participate in real life challenges and have access to other fun yet educational content 25a,b about their condition or goal. In this version, the patient is trained to become more autonomous and has the capability to enter care plan related data 28 themselves, with ability for the parent and/or medical practitioner to revalidate the patient entered data 28. It is also recognized that the modification module 44 can use the defined update frequency, can use a detected or otherwise determined deviation from a defined adherence threshold (e.g. take recorded readings using the medical device 30 between 3 to 5 times a day) by the patient during game play, and/or can use notification of completion of a specified (via the task rules 24a,b) goal (e.g. reaching the end of a game level, attainment of a specified prize, attainment of a specified number of points or other achievement quantity, or a combination thereof) in order to trigger the sending of the updates 29 to the task rules 24a,b and/or content 25a,b.

In terms of the task rules 22 defining a game, the game has the components of one or more tools, rules, and interaction with the customized version 24a,b of the task rules 22 by the patient via the user interface of their patient device 14 in communication with the task rules 24a,b stored on the patient device 14 (as a downloadable application) and/or in communication with the management device 16 hosting an online version and/or interactive component of the task rules 24a,b that define the game.

In terms of the tools of the game, one example is the medical device 30 (e.g. a glucometer, an electronic thermometer) used to supply health related data 28 to the game (as requested by the task rules 22). It is recognized that the data 28 could be supplied and processed by the processor of the device 14 during game play according to the rules 24a,b available as the local downloaded game such that the result of the processing is communicated to the management device as processed data 28 (e.g. glucose meter readings are received and processed by the device processor according to the locally stored rules 24a,b and the result of being satisfactory or otherwise matching the reading frequency and glucose level parameters specified in the rules 24a,b is then communicated as result data 28 to the management device 16, glucose meter readings are received according to the locally stored rules 24a,b and they are communicated as reading data 28 to the management device 16 in order determine if they are satisfactory or otherwise match the reading frequency and glucose level parameters specified in the rules 24a,b stored by the management device 16, or a combination thereof).

In terms of rules of the game, one example is the task rules 22 (and customized versions thereof as customized rules 24a,b) that are used during interaction with the patient to generally determine turn order, the rights and responsibilities of the patient player, and each player's goals and level of advancement (also referred to as progression) through various presented tasks in the game (e.g. provide medical device 30 reading) in order to progress to the end of the game and/or to the next level of the game. One example of progression to the end of the game, end of a game task, and/or end of a level of the game is the awarding of points, prizes, new abilities, access to new portions of the game, etc. Player rights may include when they may spend resources or move tokens. Common win conditions (e.g. attainment of a specified goal defined in the task rules 24a,b) are being first to amass a certain quota of points or tokens, having the greatest number of points tokens at the end of the game, or some relationship of one's game points or tokens to those of a comparable game person (e.g. another patient in terms of interactive games, a stated high score of the patient or of another player, etc.). For example, points and/or prizes can be awarded to the patient when the data 28 is entered regularly during game play (e.g. as directed by the task rules 24a,b), thereby providing an incentive for the patient in the game and for the parent to stay on track with regular updates.

It is recognized that the task 24a,b can be used to define a game portion concerning: mental skill or challenge tasks (e.g. guess the right answer to a question about knowledge of the patient of their disease); physical skill or coordination (e.g. hand-eye coordination) tasks such as manipulating a character or object displayed on the user interface of the device 14 through a series of obstacles (e.g. jumping a computer generated figure over a series of computer generated terrain obstacles), chance tasks such as random selection of choices and/or rolling of a computer generated die or dice or some other random number generator. It is also recognized that the task rules 24a,b can define individual turn-based play whereby the patient cannot continue the game until another player (e.g. another patient, the medical practitioner, the patent, etc.) first completes their turn related task. It is also recognized that the task rules 24a,b can define individual turn-based play whereby another player (e.g. another patient, the medical practitioner, the patent, etc.) cannot continue the game until the patient first completes their turn related task.

In terms of rewards, the patient through their interaction with the task rules 24a,b (e.g. providing user input of health related data 28 (e.g. keyboard strokes, mouse clicks, medical device readings, voice commands, etc.) in response to the tasks (e.g. in the form of user selectable links, questions with answer choices, medical device reading requirements and/or feedback, etc.) presented to the patient on the user interface of the patient device 14. In return, the patient can gain reward(s) (e.g. points, awarded prizes, etc.) by the task rules 24a,b, in return for their healthy choices/answers (including supplied readings) related to their disease. Further, based on the supplied health related data 28 by the patient, the task rules 24a,b can cause achievements to be praised coupled with new challenges and expanding horizons to be presented to the patient on the user interface of the device 14. In this manner, the patient can learn about and help with the management of their chronic disease that is provided as the theme of the game (as defined in the task rules 24a,b).

In terms of community play, the patient (via the game) can be put into contact with a community of players (e.g. a plurality of patient devices 14 communicating with each other and/or via the management device 16) in order to exchange messages, share stories, play together through duels and/or participate in collective creations. It is recognized that the content of the messages, stories, duels and/or collective creations is related to the management of their chronic disease, in particular to address active and healthy living behavior(s) as well as guidance to help change patient living behaviors from unhealthy to healthy as they related to the specific healthy parameters of their chronic disease specified in their health plan 26a,b as administered by the medical practitioner caring for the patient.

### Update Modifications 29

In terms of installation, update cycle and memory cache for the application 21, the latest version application 21 with associated game play (e.g. customized task rules 24a,b, defining the individual task(s) of the game as well as the flow between tasks—for example from one task to another within a game level and/or the flow between levels—, the possible outcome(s) of the tasks based on interaction of the patient with the application during operation of the tasks, and/or award of prizes and/or points based on proficiency of the interaction between the patient and application 21 that contributes to successful and satisfactory adherence of the patient to the health care plan 26a,b), which have their own update cycle as discussed above. To inhibit new versions of the files (e.g. task rules 24a,b and/or associated content 25a,b) from being ignored by certain browsers of the patient device 14 because of their cache configuration settings, the management device 16 (via the application interface 23) can implement a procedure that forces the association of the modification 29 (e.g. subsequently downloaded to the application 21 or portion thereof resident on the patient device 14) by using distinct files for each version. Because the files are located in different physical locations (e.g. different URLs), the browsers of the patient device 14 could consider the new files to be different files instead of using the older (e.g. unmodified) version of the files contained in their cache.

For example, all files required by the application 21 are grouped in the same folder whose name corresponds to the version number. Same goes for games associated with the application 21 (e.g. individual game specific task rules 24a,b and/or health content 25a,b). The versions.xml file can include the name of this folder so that it can be downloaded to the right place. Of course, this means that all files could be downloaded again, whether or not they've been modified (as they belong to a different folder named after the version number). Nevertheless, this slight inconvenience can make updates of the application 21 (in order to reflect changes in the health care plan 26a,b precipitated for example by the received health data 28 collected from interaction with the application 21 by the patient) easier to apply and to inhibit that modifications 29 as dictated by the clinician are not overlooked by the management device 16 and implementation of the updated application 21.

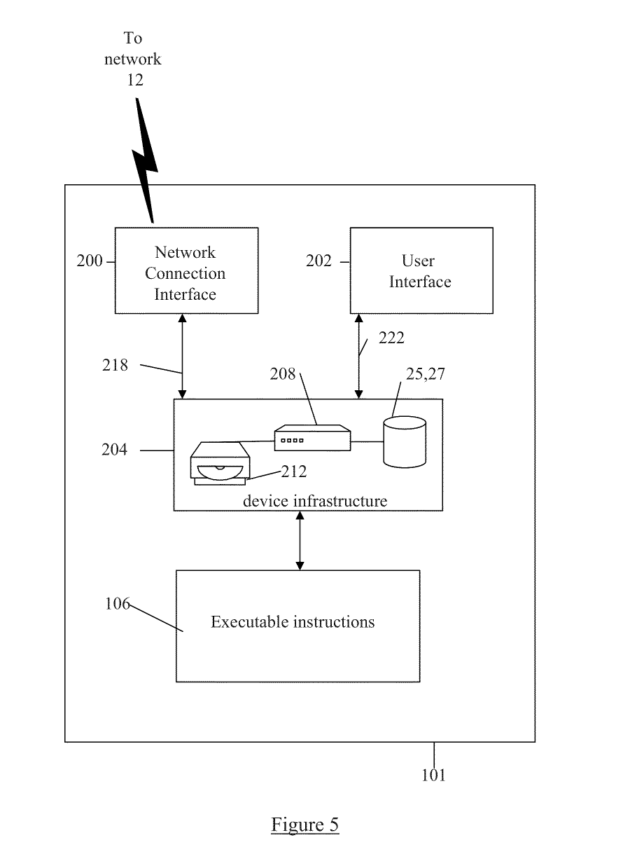

Referring to FIGS. 1 and 5, each of the above-described devices 14,16,18,20 can be implemented on one or more respective computing device(s) 101. The devices 101 in general can include a network connection interface 200, such as a network interface card or a modem, coupled via connection 218 to a device infrastructure 204. The connection interface 200 is connectable during operation of the devices 101 to the network 12 (e.g. an intranet and/or an extranet such as the Internet), which enables the devices 101 to communicate with each other as appropriate. The network 11 supports the communication 14 of the data 28,29 between the management device 16 and the patient device 14 and also supports the communication of data 28,29 between the management device 16 and the clinician device 18. It is also recognised that the management device 16 could provide for/facilitate interaction between different patient devices 14 (e.g. using the basic generic rule set 22 features and functionality) to provide for interactive task cooperation between patients (e.g. interactive game play).

Referring again to FIG. 5, the devices 101 can also have a user interface 202, coupled to the device infrastructure 204 by connection 222, to interact with a user (e.g. patient, clinician, parent). The user interface 202 can include one or more user input devices such as but not limited to a QWERTY keyboard, a keypad, a track wheel, a stylus, a mouse, a microphone and the user output device such as an LCD screen display and/or a speaker. If the screen is touch sensitive, then the display can also be used as the user input device as controlled by the device infrastructure 204.

Referring again to FIG. 5, operation of the device 101 is facilitated by the device infrastructure 204. The device infrastructure 204 includes one or more computer processors 208 and can include an associated memory 25,27 (e.g. a random access memory) for storing of care plan data 26a,b and/or task rule sets 22,24a,b and for processing communications 28,29 communicated between the devices. The computer processor 208 facilitates performance of the device 101 configured for the intended functionality (e.g. of the modules/interfaces 32,34,36,40,42,44) through operation of the network interface 200, the user interface 202 and other application programs/hardware 106 (e.g. the modules/interfaces 32,34,36,40,42,44) of the device 101 by executing related instructions. These related instructions can be provided by an operating system, and/or software applications 106 located in the memory 25,27, and/or by operability that is configured into the electronic/digital circuitry of the processor(s) 208 designed to perform the specific task(s) (e.g. of the modules/interfaces 32,34,36,40,42,44). Further, it is recognized that the device infrastructure 204 can include a computer readable storage medium 212 coupled to the processor 208 for providing instructions to the processor 208 and/or to load/update client applications 106. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid state memory card, or RAM provided in the memory module 25,27. It should be noted that the above listed example computer readable mediums 212 can be used either alone or in combination. For example, the applications 106 can include browsers used by the patients/clinicians/parents to access the Web site of the management device 16 and/or to communicate information between patients/clinicians/parents of the environment 10.

Further, it is recognized that the computing devices 101 can include the executable applications 106 comprising code or machine readable instructions for implementing predetermined functions/operations including those of an operating system, for example, in response to user command or input. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality (e.g. the modules/interfaces 32,34,36,40,42,44) provided by the systems and process of FIGS. 1,2 may be implemented in hardware, software or a combination of both. Accordingly, the use of a processor 208 as a device and/or as a set of machine readable instructions is hereafter referred to generically as a processor/module for sake of simplicity.

It will be understood that the computing devices 101 may be, for example, personal computers, personal digital assistants, mobile phones, and content players. Server computing devices 101 (e.g. for the management device 16) may additionally include a secondary storage element such as the memory (e.g. database). Each server, although depicted as a single computer system, may be implemented as a network of computer processors, as desired.

### Example Operation of the Environment 10

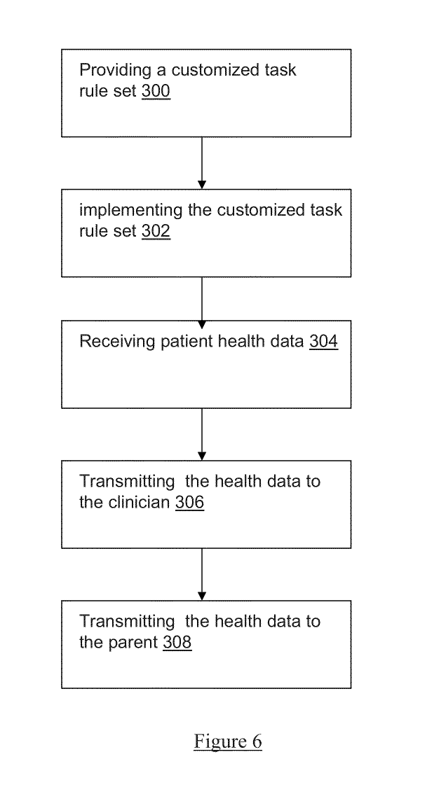

Referring to FIG. 6, shown is an example operation of the environment 10 for coordinating a series of health related tasks in interaction with the patient device 14. At step a task rule set 24a,b is customized for each patient of a plurality of patients registered with the management system 16, the customized rule set 24a,b based on a health care plan 26a,b for the patient administered by a clinician. At step 302, the task rule set customized for the respective patient is implemented by presenting content 25a,b related to the tasks 24a,b to the patient and receiving instructions based on user interaction with the presented content and associated tasks (e.g. embodied as steps in game play). At step 304, receiving patient health data dependent upon at least one specific task of the task rule set completed by the patient. At step 306, transmitting the received patient data to a clinician device via a clinician interface. At step 306, transmitting a message to a parent device including content related to the patient health data including information about the one specific task of the task rule set completed by the patient.

1. A management computer system for coordinating a series of health related tasks in interaction with a patient device, the system comprising:
a task rule set customized for each patient of a plurality of patients registered with the management system;
a user interface accessible by the patient device configured for implementing the task rule set customized for the respective patient and configured for receiving patient health data dependent upon at least one specific task of the task rule set completed by the patient;
a clinician interface accessible by a clinician device configured for transmitting the received patient data and for receiving proposed rule set modifications from the clinician device related to the transmitted patient data; and
a modification module configured for modifying at least one task of the task rule set customized for the respective patient using the proposed rule set modifications, such that subsequent specific tasks completed by the patient are influenced by the modified at least one task.

2. The system of claim 1, wherein the proposed rule set modification is related to timing of collection of the patient health data.

3. The system of claim 1, wherein the proposed rule set modification is related to a value or type of health care related reading.

4. The system of claim 1 further comprising a comparison module configured for comparison of the received patient data with corresponding data in a health care plan of the patient, such that the proposed rule set modifications are a result of the comparison.

5. The system of claim 4, wherein the health care plan is for a chronic disease and the customized task rule set contains task rules and associated content relevant to aspects of the chronic disease.

6. The system of claim 5, wherein the chronic disease is diabetes and the one specific task of the task rule set completed by the patient is operating a glucose meter.

7. The system of claim 1, wherein the one specific task of the task rule set completed by the patient is a task associated with a game play that results in a reward being assigned to the patient.

8. The system of claim 7, wherein the amount of the reward is determined based on a level of adherence to the one specific task based on an adherence threshold.

9. The system of claim 7, wherein the customized task rule set specifies the level of difficulty of the game play.

10. The system of claim 1, wherein the customized task rule set specifies the specific dietary selections available to the patient based on contents of a health care plan administered by the clinician.

11. A method for coordinating a series of health related tasks in interaction with a patient device comprising instructions stored on a physical storage for execution by a computer processor, the instructions comprising:
a task rule set customized for each patient of a plurality of patients registered with the management system;
implementing the task rule set customized for the respective patient;
receiving patient health data dependent upon at least one specific task of the task rule set completed by the patient;
transmitting the received patient data to a clinician device via a clinician interface;
receiving proposed rule set modifications from the clinician device related to the transmitted patient data; and
modifying at least one task of the task rule set customized for the respective patient using the proposed rule set modifications, such that subsequent specific tasks completed by the patient are influenced by the modified at least one task.

12. The method of claim 11, wherein the proposed rule set modification is related to timing of collection of the patient health data.

13. The method of claim 11, wherein the proposed rule set modification is related to a value or type of health care related reading.

14. The method of claim 11 further comprising instructions for comparison of the received patient data with corresponding data in a health care plan of the patient, such that the proposed rule set modifications are a result of the comparison.

15. The method of claim 14, wherein the health care plan is for a chronic disease and the customized task rule set contains task rules and associated content relevant to aspects of the chronic disease.

16. The method of claim 15, wherein the chronic disease is diabetes and the one specific task of the task rule set completed by the patient is operating a glucose meter.

17. The method of claim 11, wherein the one specific task of the task rule set completed by the patient is a task associated with a game play that results in a reward being assigned to the patient.

18. The method of claim 17, wherein the amount of the reward is determined based on a level of adherence to the one specific task based on an adherence threshold.

19. The method of claim 17, wherein the customized task rule set specifies the level of difficulty of the game play.

20. The method of claim 11, wherein the customized task rule set specifies the specific dietary selections available to the patient based on contents of a health care plan administered by the clinician.

21. The method of claim 11, wherein a computer generated avatar assigned to an account of the patient is presented to the patient along with health condition information of the avatar based on a result of the one specific task of the task rule set completed by the patient.

22. A method for coordinating a series of health related tasks in interaction with a patient device comprising instructions stored on a physical storage for execution by a computer processor, the instructions comprising:
a task rule set customized for each patient of a plurality of patients registered with the management system, the customized rule set based on a health care plan for the patient administered by a clinician;
implementing the task rule set customized for the respective patient;
receiving patient health data dependent upon at least one specific task of the task rule set completed by the patient;
transmitting the received patient data to a clinician device via a clinician interface; and
transmitting a message to a parent device including content related to the patient health data including information about the one specific task of the task rule set completed by the patient.

23. The method of claim 22, wherein the one specific task of the task rule set completed by the patient is a task associated with a game play that results in a reward being assigned to the patient.

24. The method of claim 23, wherein the amount of the reward is determined based on a level of adherence to the one specific task based on an adherence threshold.

25. The method of claim 22 further comprising the instructions of: modifying at least one task of the task rule set customized for the respective patient using the proposed rule set modifications, such that subsequent specific tasks completed by the patient are influenced by the modified at least one task.
